(19) United States
(12) Patent Application Publication
(10) Pub. No.: US 2007/0252435 A1
(43) Pub. Date: Nov. 1, 2007

(54) High capacity mobile electric power source

(76) Inventors: Carlos Coe, San Marcos, TX (US); Guadalupe Carranco, San Marcos, TX (US); Paul W. Heald, San Marcos, TX (US); Mark E. Hood, New Braunfels, TX (US); Aeron N. Hurst, San Marcos, TX (US); Bill B. Kuhn, New Braunfels, TX (US)

Correspondence Address: ANTHONY EDW. J CAMPBELL, PO BOX 160370, AUSTIN, TX, 78716, US

(21) Appl. No.: 11/411,521

(22) Filed: Apr. 26, 2006

(51) Int. Cl. B60L 1/00

(52) U.S. Cl. 307/10.1

(57) ABSTRACT

An high capacity mobile electric power source having a toolbox for attachment to a truck bed. A battery is connected to the toolbox bottom. The battery is high capacity, maintenance free, 12-volt direct current battery. An inverter is connected to and is in thermal communication with the toolbox rear-gate facing wall for enhanced thermal dissipation. The inverter is electrically connected to the battery positive pole connection. A first electrical outlet is connected to the toolbox rear-gate facing wall adjacent the driver side sidewall, the first electrical outlet is electrically connected to the inverter.

### CLAIM OF PRIORITY

This application claims the benefit of U.S. Provisional Application No. 60/674,573, filed on Apr. 25, 2005.

### BACKGROUND OF THE INVENTION

1. Field of the Invention

The present embodiment of the invention relates to a high capacity mobile electric power source for use in connection with portable power inverters. A self contained, automatically recharging, battery operated electric power source of 100 Ahr capacity or greater for installation in vehicles for the purpose of supplying 120 volt AC and 12 VDC electrical power to electric tools, lights and other devices. The high capacity mobile electric power source has-particular utility in connection with portable power inverters for use in pickup trucks having high capacity batteries, the inverter connected to the toolbox for added heat dissipation, ground fault interrupter circuits and battery isolation circuit.

2. Description of the Prior Art

High capacity mobile electric power sources are desirable for providing alternating current for use by electrical power tools. The invention consists of one or more 12 volt DC batteries of 100 Ahr capacity or greater and a means to convert 12 volt DC power into 120 volt AC electrical power which is incorporated inside of an enclosure. The device is intended for installation in a truck, van or service vehicle. Electrical connections run from the vehicle's alternator or a supplemental alternator to enable the device batteries to be recharged. The invention further consists of a voltage regulator installed for the control of the alternator which utilizes a proprietary charging algorithm to maximize the condition and life of the batteries. The preferred embodiment features one or more 120V GFCI electrical receptacles and other power outlets. These receptacles provide electrical power for construction, camping, emergency services and commercial activities for extended periods of time with the vehicle engine off before needing to be recharged. A need was felt for an alternating current power box that supplies in excess of 100 amps at 120 VAC, had the inverter thermally conducting to the toolbox for additional heat dissipation and an isolator circuit.

The use of portable power inverters is known in the prior art. For example, U.S. Pat. No. 6,596,941 to Tripoli discloses AC electrical power delivery system for a pickup truck bed utility box for an AC electrical power delivery system for installation into a utility box attached to the bed of a pickup truck. This system delivers AC electrical power for operating light-duty equipment including power hand tools and electrical equipment to an included AC outlet connectable to a side wall of the utility box. An electrical power inverter is provided of the type which converts incoming DC electrical power to AC electrical power. The inverter is installable into the utility box in proximity to, and having an AC power output in electrical communication with, the AC outlet. This system may also include a separate DC electrical power storage battery or utilize the battery of the pickup truck. A wiring harness is connectable at one end thereof to a DC input of the inverter and extendable along the body of the pickup truck and connectable at another end of the wiring harness to the DC storage battery whereby DC electrical power is transferred by the wiring harness from the storage battery to the inverter when AC electrical power is demanded at the AC outlet. However, the Tripoli '941 patent does not attach the inverter to a pickup truck toolbox sidewall for added heat dissipation, does not have AC output of greater than 100 amps at 120 VAC, does not use deep discharge batteries, and cannot work for an extended time without running the truck. The Tripoli '941 patent connects to the vehicle battery whereas the instant invention connects directly to the engine alternator, and is limited to inverter systems drawing less than 100 DC amps for short periods of time without starting the vehicle engine whereas the instant invention delivers more than 100 Ahr for extended periods with the engine off. The Tripoli '941 patent does not teach taking the place of the vehicle starting battery, having multiple batteries mounted in the enclosure, mounting multiple batteries with bus bars, having multiple power outlets of different voltage and current ratings, providing 12 VDC power for appliances or jump starting. Additionally, the Tripoli '941 reference does not teach applications beyond popular utility boxes attached to the bed of a pickup truck, protecting the vehicle starting battery from discharge below a set voltage with a low voltage disconnect or having a custom charging profile in the voltage regulator to maintain the battery condition. The Tripoli '941 reference does not teach replacing the existing alternator with a high amp output alternator as a key component in maintaining the battery condition, using batteries featuring low internal resistance for maximum power availability, recharging cycle life and low out gassing or venting any batteries in the enclosure to the exterior to avoid corrosion.

Similarly, U.S. Pat. No. 5,982,138 to Krieger discloses a portable electrical energy source includes a portable housing having an outer surface and defining an interior space. A direct current battery is disposed in the interior space. A direct current socket is supported on the housing and electrically coupled to the battery for supplying direct current from the battery to a device outside the housing. An inverter is provided for converting direct current into alternating current and includes an electrical lead have a male plug adapted for being electrically connected to the battery via the direct current socket and an electrical outlet for supplying alternating electrical current to a device outside the housing. The inverter is removably attached to the outer surface of the housing so that the inverter can be ported together with the battery inside the housing and selectively separated from the housing and used independently of the battery in the housing. However, the Krieger '138 patent does not attach the inverter to a pickup truck toolbox sidewall for added heat dissipation, does not have AC output of greater than 100 amps at 120 VAC, does not use deep discharge batteries, and cannot work for an extended time without connecting to an external power source for recharging. The Krieger '138 reference does provide portable 120 VAC and 12 VDC power for jump starting and small loads, however, the scale and capability of the instant invention is tremendously greater beginning at 100 Ahr capacity. The Krieger '138 reference teaches a 3 Ahr battery whereas the instant invention is greater than 100 Ahr, a 50 watt inverter whereas the instant invention is greater than 2000 watts, a 5 lbs weight whereas the instant invention is greater than 300 lbs and handheld portability whereas the instant invention is vehicle mounted. The Krieger '138 patent connects to the vehicle battery whereas the instant invention connects directly to the engine alternator, and is limited to inverter systems drawing less than 100 DC amps for short periods of time without starting the vehicle engine whereas the instant invention delivers more than 100 Ahr for extended periods with the engine off. The Krieger '138 patent does not teach taking the place of the vehicle starting battery, having multiple batteries mounted in the enclosure, mounting multiple batteries with bus bars, having multiple power outlets of different voltage and current ratings, providing 12 VDC power for appliances or jump starting. Additionally, the Knieger '138 reference does not teach applications beyond popular utility boxes attached to the bed of a pickup truck, protecting the vehicle starting battery from discharge below a set voltage with a low voltage disconnect or having a custom charging profile in the voltage regulator to maintain the battery condition. The Krieger '138 reference does not teach replacing the existing alternator with a high amp output alternator as a key component in maintaining the battery-condition, using batteries featuring low internal resistance for maximum power availability, recharging cycle life and low out gassing or venting any batteries in the enclosure to the exterior to avoid corrosion.

Likewise, U.S. Pat. No. 2,978,596 to Robirds discloses a portable conversion unit that combines a storage battery, a DC charging circuit having one end terminating a the storage battery and its other end terminating in a DC input output receptacle and an AC charging circuit having one end terminating in an AC input receptacle and its other end terminating at the battery. An AC output receptacle means is connected t the battery through the inverter. A housing consists of first and second housing members being adapted to receive the battery and the second housing member being adapted to receive the AC input receptacle and charging circuit. The DC input output receptacles and the inverter. A common connector plug is interposed between the first and second housing members and the battery. The AC and DC charging circuits and the AC output and inverter circuits and the first and second housing members have cooperative edge portions and latch means thereupon adapted to demountably secure the first and second housing members in operative engagement with each other. However, the Robirds '696 patent does not attach the inverter to a pickup truck toolbox sidewall for added heat dissipation, does not have AC output of greater than 100 amps at 120 VAC, does not use deep discharge batteries, and cannot work for an extended time without connecting to a power source for recharging. Although the Robirds '956 reference provides portable 120 VAC and 12 VDC power for jump starting and small loads, the scale and capability of the instant invention is tremendously greater beginning at 100 Ahr capacity. The Robirds '956 reference teaches a 3 Ahr battery whereas the instant invention is greater than 100 Ahr, a 50 watt inverter whereas the instant invention is greater than 2000 watts, a 5 lbs weight whereas the instant invention is greater than 300 lbs and handheld portability whereas the instant invention is vehicle mounted. The Robirds '956 patent connects to the vehicle battery whereas the instant invention connects directly to the engine alternator, and is limited to inverter systems drawing less than 100 DC amps for short periods of time without starting the vehicle engine whereas the instant invention delivers more than 100 Ahr for extended periods with the engine off. The Robirds '956 patent does not teach taking the place of the vehicle starting battery, having multiple batteries mounted in the enclosure, mounting multiple batteries with bus bars, having multiple power outlets of different voltage and current ratings, providing 12 VDC power for appliances or jump starting. Additionally, the Robirds '956 reference does not teach applications beyond popular utility boxes attached to the bed of a pickup truck, protecting the vehicle starting battery from discharge below a set voltage with a low voltage disconnect or having a custom charging profile in the voltage regulator to maintain the battery condition. The Robirds '956 reference does not teach replacing the existing alternator with a high amp output alternator as a key component in maintaining the battery condition, using batteries featuring low internal resistance for maximum power availability, recharging cycle life and low out gassing or venting any batteries in the enclosure to the exterior to avoid corrosion.

Further likewise, U.S. Pat. No. 3,694,729 to Jones discloses a portable electric power apparatus that has two portable battery packs removably mounted on a truck and connected to the truck's electrical system. Each pack contains four 6-volt battery units which are wired to a battery pack connector mounted at the rear of the battery pack housing. Means are provided for connecting the battery units in parallel for charging by the truck generator alternator or battery. When the pack is withdrawn from the truck and used to power a tool, the battery units are connected in suitable series—parallel—to provide output voltages greater than the charging voltage. However, the Jones '729 patent does not provide AC power and does not have an inverter. The Jones '729 patent connects to the vehicle battery whereas the instant invention connects directly to the engine alternator, and is limited to inverter systems drawing less than 100 DC amps for short periods of time without starting the vehicle engine whereas the instant invention delivers more than 100 Ahr for extended periods with the engine off. The Jones '729 patent does not teach taking the place of the vehicle starting battery, having multiple batteries mounted in the enclosure, mounting multiple batteries with bus bars, having multiple power outlets of different voltage and current ratings, providing 12 VDC power for appliances or jump starting. Additionally, the Jones '729 reference does not teach applications beyond popular utility boxes attached to the bed of a pickup truck, protecting the vehicle starting battery from discharge below a set voltage with a low voltage disconnect or having a custom charging profile in the voltage regulator to maintain the battery condition. The Jones '729 reference does not teach replacing the existing alternator with a high amp output alternator as a key component in maintaining the battery condition, using batteries featuring low internal resistance for maximum power availability, recharging cycle life and low out gassing or venting any batteries in the enclosure to the exterior to avoid corrosion. Additionally the Jones '729 reference does not provide AC power and the batteries are removed for utilization

Correspondingly, U.S. Pat. No. 6,571,949 to Burrus, IV et al. discloses a power toolbox for vehicles that charges power tools and batteries while the vehicle is driven. A preferred embodiment is intended to be placed in a pick-up truck bed. The toolbox is coupled to the vehicular automotive system, and electrical power is delivered through electrical contacts in the toolbox to modular compartments that hold power tools or batteries in a nested fashion. When the vehicle is running, any battery or tool coupled to a compartment is charged. The compartments may be of different shapes and sizes and may include electrical circuitry to modulate the voltage and current from the vehicular electrical system. An optional manual switch is provided to disengage the toolbox from the vehicular electrical system. However, the Burrus, IV et al. '949 patent is for DC only and does not provide an inverter. The Burrus '949 reference is an electrified version of a standard pickup truck tool box which is connected to the electrical system of the truck and customized to house low voltage DC battery powered hand tools and their rechargeable batteries. The Burrus '949 reference 'focus is on the modular tool and battery cradles, rechargeable battery connection points and a step down 6 VDC voltage regulator. The instant invention does provide a 120V power strip internal to the enclosure were a battery charger could be attached as well as variety of other appliances and it does not include any specific provisions for mounting power tools or their battery rechargers.

Further, U.S. Pat. No. 6,476,509 to Chen et al. discloses a mobile AC power system comprising an alternator installable in a vehicle, and a power converter. The alternator includes an AC output port electrically connected to the stator windings of the alternator for receiving the AC output signal, and providing access to the AC output signal such that the AC output signal can provide AC power at a location outside of the alternator's housing. The power converter is provided with a transformer, a frequency changer, and an electrical outlet. The transformer receives the AC output signal from the AC output port and increases the voltage of the AC output signal to at least about 120 V. The frequency changer receives the AC output signal having the increased voltage, and converts the frequency of the AC output signal to a frequency between about 45 to about 65 Hz. The electrical outlet receives the AC output signal having the increased voltage and converted frequency. An electrical implement, such as a hand drill, can be plugged into the electrical outlet so as to provide power for operating the electrical implement. However, the Chen et al. '509 patent does not have a battery and requires a running motor to operate. The Chen '509 device is a power converter which is directly connected to the vehicle alternator and takes 12 VAC power directly from the alternator windings before it is converted into DC and steps it up to 120 VAC. It is classified as a portable generator but one wherein the vehicle engine and alternator have replaced the typical generator's gasoline engine and alternator. The Chen '509 device can supply 120 VAC and 12 VDC power but in all other respects is totally unrelated to the instant invention. It contains no batteries and works only with the engine on. In fact it includes a modified pipe clamp which wedges between the steering wheel and accelerator pedal to keep the engine reved up.

Further yet, U.S. Pat. No. 6,577,098 to Griffey et al. discloses an apparatus and method for providing a mobile AC power supply wherein the DC current of battery is converted by a power inverter electrically coupled to the battery terminals and the inverter is also mechanically coupled the battery. An AC outlet is positioned to provide a source of power and the unit has a power input being configured to receive a charging current for the battery. The AC outlet is disabled when the power input is receiving a charge. However, the Griffey et al. '098 patent does not charge from the vehicle and charges from a household electrical outlet. The Griffey '098 device is made up of a small inverter that has been adapted to fit on the side of a 12 VDC automotive battery and incorporates a small charger to recharge the battery. A primary feature is handheld portability. This device is similar to Krieger '138 device in that it is handheld, has a system weight of 50 lbs, a 280 watt inverter and a charger which requires 26 hours to recharge its single battery.

Still further, U.S. Pat. No. 6,464,276 to Gruich discloses an aerodynamic storage unit for a truck bed with a load floor that extends between a pair of longitudinal side walls. This storage unit has an inner wall which is spaced apart from one of the pair of longitudinal side walls so that a storage space is defined between the inner wall and the side wall. The inner wall member has a lower edge located on the load floor and an upper edge which is joined to the side wall. At least a portion of the inner wall member between the upper and lower edges is outwardly inclined. At least one access opening is provided in the inner wall. A door is located in the access opening. The door has a lower edge which is connected to the inner wall using a hinge, and an upper end. The lower end of the door is closer to the load floor than the upper end of the door. The door operates to open inwardly so that the storage space can be accessed through the opening when the door is opened. However, the Gruich '276 patent does not attach the inverter to a pickup truck toolbox sidewall for added heat dissipation, does not have AC output of greater than 100 amps at 120 VAC, does not use deep discharge batteries, and cannot work for an extended time without connecting to a power source for recharging.

Still further yet, U.S. Pat. No. 5,905,356 to Wells discloses a solar powered charger for vehicular accessories and cordless such as battery powered hand tools and cellular telephones. The charging system includes a solar collection assembly having-at least one light energy receiving panel. The collection assembly is mountable to a carrying vehicle. A multi-position connector is coupled to the receiving panel for facilitating the positioning of the panel toward a light source such as the sun or vehicle headlights. A power receiver is electrically connected to the receiving panel for accepting electricity generated at the solar collection assembly. The power receiver has a docking station for releasably receiving a battery powered portable unit such as a powered hand tool or a cellular telephone requiring recharging. The invention further includes a carrying motor vehicle. The solar collection assembly is coupled to the carrying motor vehicle by the multi-position connector. The carrying motor vehicle is a pick-up truck having a tool box located in a bed of the truck and the solar collection assembly is coupled to the tool box by the multi-position connector. The power receiver is positioned within the tool box located in a bed of the truck. However, the Wells '356 patent does not does not have AC output of greater than 100 amps at 120 VAC, does not use deep discharge batteries, and cannot work for an extended time without connecting to an external power source for recharging.

Yet still further, U.S. Pat. No. 6,747,246 to Crandell, III discloses a Integrated mobile tool and welder power supply system includes a primary DC power source coupled to a power supply chassis for supplying DC power to DC-operated power equipment such as welders and AC power to AC-powered equipment such as standard AC power tools. The power supply chassis houses a power inverter for transforming DC power from the primary DC power source into AC power and one or more power converters for supplying a recharging current to the primary DC power source from one or both of an external AC power source or an external DC power source. The power supply system can be configured such that if an external AC power source is available, that AC power source is electrically coupled to an AC output terminal for supplying AC-powered tools. In one embodiment, the switching of AC output power from the power inverter to the external AC power source may be overridden by means of an AC output mode selection switch. In another embodiment, the system is equipped with a DC transfer switch, a motor drive output and a motor demand indicator input so that a DC motor (e.g., the welding wire spool feed motor DC welder) may be driven from a regulated DC power source as opposed to the unregulated primary DC power source. However, the Crandell, III '246 patent does not does not have AC output of greater than 100 amps at 120 VAC, does not use deep discharge batteries, and cannot work for an extended time without connecting to an external power source for recharging. The Crandell '246 is a portable, battery operated power supply for DC welding that distinguishes itself from previous devices by also offering AC power. While the device is welding specific to the point of providing DC power to run a DC wire feed motor for a welding tool it touts added versatility in providing AC power for additional electric power tools. The focus of the Crandell '246 reference is to protect the specialized power supply. This power supply is about the size of an inverter and housed in an extruded aluminum casing. It contains a DC to DC converter, both AC and DC recharging circuits, a DC to AC inverter, a DC output and a relatively complex switching circuitry to establish an operating protocol between the respective pieces of the power supply. It is a hand truck based configuration whereas the instant invention is vehicle based, it may be recharged from a truck but is not permanently connected and it is described as having plurality of batteries connected in series. The Crandell '246 patent connects to the vehicle battery whereas the instant invention connects directly to the engine alternator, and is limited to inverter systems drawing less than 100 DC amps for short periods of time without starting the vehicle engine whereas the instant invention delivers more than 100 Ahr for extended periods with the engine off. The Crandell '246 patent does not teach taking the place of the vehicle starting battery, having multiple batteries mounted in the enclosure, mounting multiple batteries with bus bars, having multiple power outlets of different voltage and current ratings, providing 12 VDC power for appliances or jump starting. Additionally, the Crandell '246 reference does not teach applications beyond popular utility boxes attached to the bed of a pickup truck, protecting the vehicle starting battery from discharge below a set voltage with a low voltage disconnect or having a custom charging profile in the voltage regulator to maintain the battery condition. The Crandell '246 reference does not teach replacing the existing alternator with a high amp output alternator as a key component in maintaining the battery condition, using batteries featuring low internal resistance for maximum power availability, recharging cycle life and low out gassing or venting any batteries in the enclosure to the exterior to avoid corrosion.

Yet further still, U.S. Pat. No. 4,376,250 to Baker, Jr. et al. discloses a Portable power source providing a source of alternating power for power devices is disclosed. The apparatus comprises a frame member having a plurality of ground engaging wheels for transporting the frame member along the ground. The frame member carries a plurality of DC storage means therein. A transformer means carried on the frame has a low voltage center tapped winding, a line voltage winding, and a high voltage winding. The low voltage center tapped winding is in communication with the DC storage means, and the line voltage winding is operable to produce an AC output voltage suitable for powering devices. A plurality of controllable rectifier means is in communication with both the high voltage winding and the low voltage center tapped winding. The rectifier means are operable to alternately provide a conduction path for said DC storage means through both halves of the low voltage center tapped winding. However, the Baker, Jr. et al. '250 patent does not attach the inverter to a pickup truck toolbox sidewall for added heat dissipation, does not have AC output of greater than 100 amps at 120 VAC, does not use deep discharge batteries, and cannot work for an extended time without connecting to an external power source for recharging. The Baker '250 device is a battery operated portable AC power supply in a wheeled cart configuration for powering electric construction tools. It consists of a plurality of “deep discharge” automotive type batteries, a large transformer, and an AC inverter and recharge circuit which is the focus of the patent. The Baker '250 device is hand cart based configuration whereas the instant invention is vehicle based, is only configured to be recharged by plugging in to a 120V line source and is described as having plurality of batteries connected in series. The Baker '250 patent connects to the vehicle battery whereas the instant invention connects directly to the engine alternator, and is limited to inverter systems drawing less than 100 DC amps for short periods of time without starting the vehicle engine whereas the instant invention delivers more than 100 Ahr for extended periods with the engine off. The Baker '250 patent does not teach taking the place of the vehicle starting battery, having multiple batteries mounted in the enclosure, mounting multiple batteries with bus bars, having multiple power outlets of different voltage and current ratings, providing 12 VDC power for appliances or jump starting. Additionally, the Baker '250 reference does not teach applications beyond popular utility boxes attached to the bed of a pickup truck, protecting the vehicle starting battery from discharge below a set voltage with a low voltage disconnect or having a custom charging profile in the voltage regulator to maintain the battery condition. The Baker '250 reference does not teach replacing the existing alternator with a high amp output alternator as a key component in maintaining the battery condition, using batteries featuring low internal resistance for maximum power availability, recharging cycle life and low out gassing or venting any batteries in the enclosure to the exterior to avoid corrosion.

Additionally, U.S. Pat. No. 5,111,127 to Johnson discloses a portable power supply having a rechargeable battery in a housing mounted on a portable frame. An inverter/converter unit, attached to the frame, is hardwired to the battery for conversion of DC power to AC power and for recharging the battery from an external AC source. Power distribution means are provided for distributing DC and AC Power. Photovoltaic panels are mounted to the frame for recharging the battery. However, the Johnson '127 patent does not attach the inverter to a pickup truck toolbox sidewall for added heat dissipation, does not have AC output of greater than 100 amps at 120 VAC, does not use multiple batteries, and cannot work for an extended time without connecting to an external power source for recharging. The Johnson '127 device is a battery operated portable AC power supply in a hand truck configuration for powering small appliances. It consists of a single, conventional “deep discharge marine” type battery, an AC inverter and AC recharge circuit and four solar panels which are the unique feature of this patent. It is a hand truck based configuration whereas the instant invention is vehicle based, it may be recharged by a 120V line source or attached solar panels, it is described as having a single 93 Ahr battery and it includes a 1200 watt inverter. The Johnson '127 patent connects to the vehicle battery whereas the instant invention connects directly to the engine alternator, and is limited to inverter systems drawing less than 100 DC amps for short periods of time without starting the vehicle engine whereas the instant invention delivers more than 100 Ahr for extended periods with the engine off. The Johnson '127 patent does not teach taking the place of the vehicle starting battery, having multiple batteries mounted in the enclosure, mounting multiple batteries with bus bars, having multiple power outlets of different voltage and current ratings, providing 12 VDC power for appliances or jump starting. Additionally, the Johnson '127 reference does not teach applications beyond popular utility boxes attached to the bed of a pickup truck, protecting the vehicle starting battery from discharge below a set voltage with a low voltage disconnect or having a custom charging profile in the voltage regulator to maintain the battery condition. The Johnson '127 reference does not teach replacing the existing alternator with a high amp output alternator as a key component in maintaining the battery condition, using batteries featuring low internal resistance for maximum power availability, recharging cycle life and low out gassing or venting any batteries in the enclosure to the exterior to avoid corrosion.

Still additionally, United States Patent Disclosure 2004/0239287 to Batts-Gowins discloses a Portable AC power supply with multiple uses a highly versatile AC portable power supply which can be used in a variety of situations to power 110 V AC common household devices, including holiday lighting or driveway or path lighting. It can also be used to jump start a dead vehicle battery either by a trickle charge via the vehicle's lighter outlet. The portable AC unit is provided with at least 3 sets of recharging plugs so that the user can recharge it with solar panels, or 110 V standard household current or 12 V vehicle battery. The portable AC unit is also provided with a timer to automatically turn it on and off at a preset time. In addition, it is provided with a display unit which can display the time left until recharge is needed, and when it is being recharged, how long it will take to fully charge. However, the Batts-Gowins '287 patent does not attach the inverter to a pickup truck toolbox sidewall for added heat dissipation, does not have AC output of greater than 100 amps at 120 VAC, does not use deep discharge batteries, and cannot work for an extended time without connecting to an external power source for recharging. The Batts-Gowins '287 device is a small portable AC power supply primarily intended for remote holiday lighting displays. It features a small NiCad battery that can be recharged from a solar panel, 120V line source or the 12 VDC power from a vehicle's lighter plug. The scale and intention of this device is entirely different from the instant invention.

Lastly, WIPO Patent Number WO 03/058736 to Morris discloses a reserve battery for use in electrochemical cell systems. The structure includes a dry component housing including a plurality of dry components including an anode and a cathode. One end of the dry component housing comprises and electrolyte concentrate reservoir. The electrolyte concentration reservoir and the dry components are in communication via a flow control device, aperture or system. An electrochemical cell is formed using the structure, in addition to a source. When the water is added in the proximity of the electrolyte concentration reservoir, diluted electrolyte is introduced through an electrolyte flow control device the cell is activated. However, the Morris '736 patent does not attach to a pickup truck toolbox sidewall for heat dissipation, does not have AC output of greater than 100 amps at 120 VAC, does not use deep discharge batteries, and cannot work for an extended time without connecting to an external power source for recharging.

While the above-described devices fulfill their respective, particular objectives and requirements, the aforementioned patents do not describe a high capacity mobile electric power source that allows portable power inverters for use in pickup trucks having high capacity batteries, the inverter connected to the toolbox for added heat dissipation, ground fault interrupter circuits and battery isolation circuit. The Tripoli '941, Krieger '138, Robirds '696, Jones '729, Burrus, IV et al. '949, Chen et al. '509, Griffey et al. '098, Gruich '276, Wells '356, Crandell, III '246, Baker, Jr. et al. '250, Johnson '127, Batts-Gowins '287 and Morris '736 patents make no provision for attaching the inverter to a pickup truck toolbox sidewall for heat dissipation, do not have AC output of greater than 100 amps at 120 VAC, do not use deep discharge batteries, and cannot work for an extended time without connecting to an external power source for recharging.

Therefore, a need exists for a new and improved high capacity mobile electric power source which can be used for portable power inverters for use in pickup trucks having high capacity batteries, the inverter connected to the toolbox for added heat dissipation, ground fault interrupter circuits and battery isolation circuit. In this regard, the present embodiment of the invention substantially fulfills this need.

In this respect, the high capacity mobile electric power source according to the present embodiment of the invention substantially departs from the conventional concepts and designs of the prior art, and in doing so provides an apparatus primarily developed for the purpose of portable power inverters for use in pickup trucks having high capacity batteries, the inverter connected to the toolbox for added heat dissipation, ground fault interrupter circuits and battery isolation circuit.

### SUMMARY OF THE INVENTION

In view of the foregoing disadvantages inherent in the known types of portable power inverters now present in the prior art, the present embodiment of the invention provides an improved high capacity mobile electric power source, and overcomes the above-mentioned disadvantages and drawbacks of the prior art. As such, the general purpose of the present embodiment of the invention, which will be described subsequently in greater detail, is to provide a new and improved high capacity mobile electric power source and method which has all the advantages of the prior art mentioned heretofore and many novel features that result in a high capacity mobile electric power source which is not anticipated, rendered obvious, suggested, or even implied by the prior art, either alone or in any combination thereof.

To attain this, the present embodiment of the invention essentially has a high capacity mobile electric power source having a toolbox for attachment to a truck bed. A battery is connected to the toolbox bottom. The battery is high capacity, maintenance free, 12-volt direct current battery. An inverter is connected to and is in thermal communication with the toolbox rear-gate facing wall for enhanced thermal dissipation. The inverter is electrically connected to the battery positive pole connection. A first electrical outlet is connected to the toolbox rear-gate facing wall adjacent the driver side sidewall, the first electrical outlet is electrically connected to the inverter.

There has thus been outlined, rather broadly, the more important features of the embodiment of the invention in order that the detailed description thereof that follows may be better understood and in order that the present contribution to the art may be better appreciated.

The present embodiment of the invention may also include a second electrical outlet, an isolator circuit and a secondary alternator. There are, of course, additional features of the present embodiment of the invention that will be described hereinafter and which will form the subject matter of the claims attached.

Numerous objects, features and advantages of the present embodiment of the invention will be readily apparent to those of ordinary skill in the art upon a reading of the following detailed description of presently preferred, but nonetheless illustrative, embodiments of the present embodiment of the invention when taken in conjunction with the accompanying drawings. In this respect, before explaining the current embodiment of the embodiment of the invention in detail, it is to be understood that the embodiment of the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present embodiment of the invention.

It is therefore an object of the present embodiment of the invention to provide a new and improved high capacity mobile electric power source that has all of the advantages of the prior art portable power inverters and none of the disadvantages.

It is another object of the present embodiment of the invention to provide a new and improved high capacity mobile electric power source that may be easily and efficiently manufactured and marketed.

Another object of the present embodiment of the invention is to provide a new and improved high capacity mobile electric power source that has a low cost of manufacture with regard to both materials and labor, and which accordingly is then susceptible of low prices of sale to the consuming public, thereby making such high capacity mobile electric power source economically available to the buying public.

Still another object of the present embodiment of the invention is to provide a new high capacity mobile electric power source that provides in the apparatuses and methods of the prior art some of the advantages thereof, while simultaneously overcoming some of the disadvantages normally associated therewith.

Still yet another object of the present embodiment of the invention is to provide a mobile 120 VAC electrical power for a variety of outdoor uses.

Further still another object of the present embodiment of the invention is to provide a mobile power system that recharges during normal operation of the vehicle.

Still further another object of the present embodiment of the invention is to provide instantly available 120 VAC power.

An even further object of the present embodiment of the invention is to provide secured operation with the lid down and locked.

Yet another object of the present embodiment of the invention is to provide a mobile power source that replaces liquid fueled portable generators and eliminates the need for gas and diesel fuel to operate these.

Still yet another object of the present embodiment of the invention is to provide a lower cost power solution.

Further still another object of the present embodiment of the invention is to provide a mobile power source that reduces pollution from generators.

Yet another object of the present embodiment of the invention is to provide a mobile power source that is noise free and completely quiet.

It is another object of the present embodiment of the invention to provide circuitry to prevent against electrical shocks in the event of a ground fault.

An even further object of the present embodiment of the invention is to provide a mobile power unit that is maintenance-free.

Still another object of the present embodiment of the invention is to provide a mobile power source that makes 120 VAC instantly available.

Yet another object of the invention is to provide a power supply that replaces the starting battery of the vehicle with a maintenance-free power source.

Still yet another object of the present embodiment of the invention is to provide 12 VDC high current power for vehicle jump-starting.

Further still another object of the present embodiment of the invention is to provide 12 VDC for 12-volt appliances.

Further still another object of the present embodiment of the invention is to provide an enclosure which vents the batteries to the out of doors to avoid enclosure and vehicle corrosion.

Even still another object of the present embodiment of the invention is to provide a high capacity mobile electric power source having high capacity batteries for extended use.

Still yet another object of the present embodiment of the invention is to provide a high capacity mobile electric power source with the inverter connected to the toolbox for added heat dissipation.

Lastly, it is an object of the present embodiment of the invention is to provide a high capacity mobile electric power source having ground fault interrupter circuits and battery isolation circuit.

These together with other objects of the embodiment of the invention, along with the various features of novelty that characterize the embodiment of the invention, are pointed out with particularity in the claims annexed to and forming a part of this disclosure. For a better understanding of the embodiment of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The embodiment of the invention will be better understood and objects other than those set forth above will become apparent when consideration is given to the following detailed description thereof. Such description makes reference to the annexed drawings wherein:

FIG. 1 is a diagram view of the preferred embodiment of the high capacity mobile electric power source constructed in accordance with the principles of the present invention.

FIG. 2 is a diagram view of the high capacity mobile electric power source of the present embodiment of the invention.

FIG. 3 is a diagram view of the high capacity mobile electric power source of the present embodiment of the invention.

The same reference numerals refer to the same parts throughout the various figures.

### DESCRIPTION OF THE PREFERRED EMBODIMENT

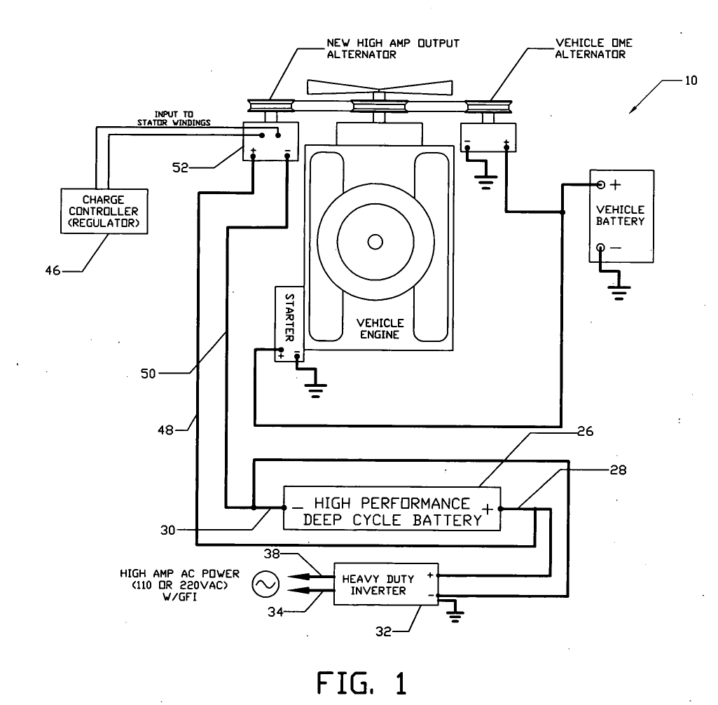

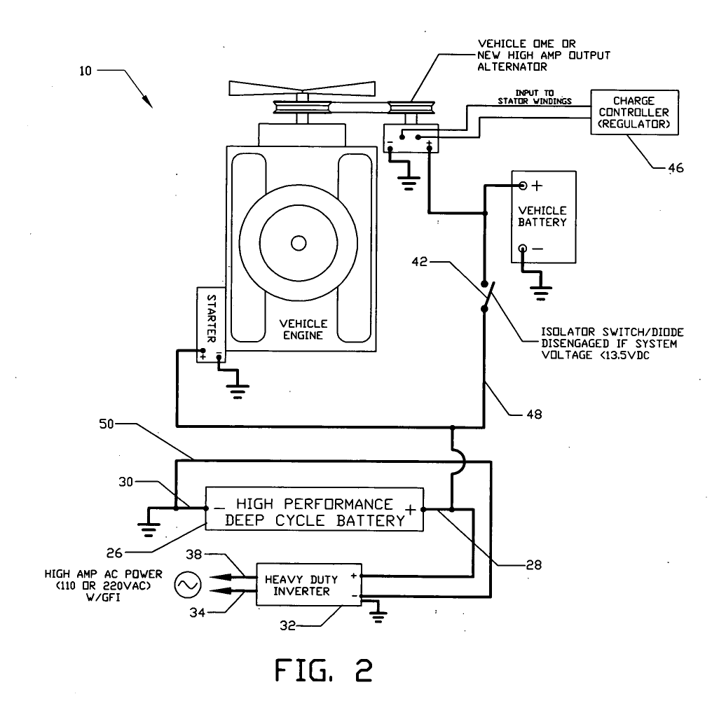

Referring now to the drawings, and particularly to FIGS. 1-4, a preferred embodiment of the high capacity mobile electric power source of the present invention is shown and generally designated by the reference numeral 10.

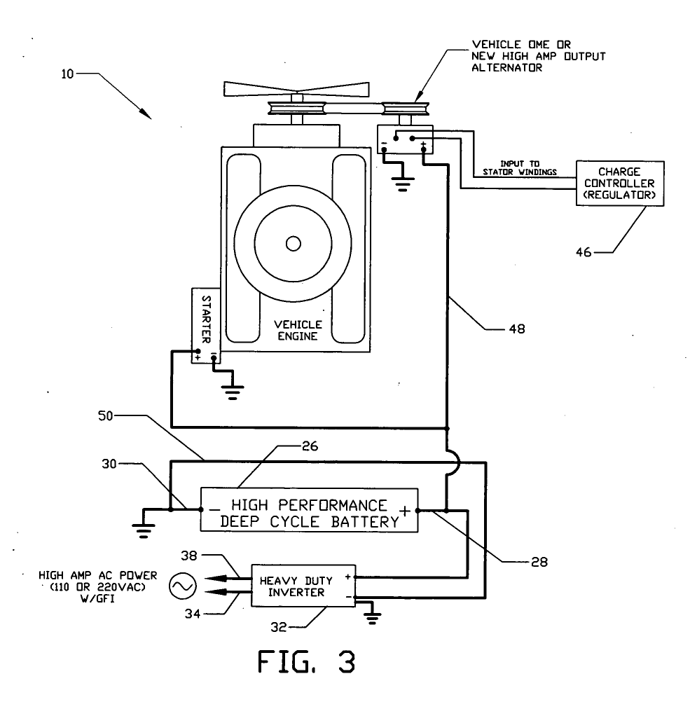

In FIG. 1, the new and improved high capacity mobile electric power source 10 of the present invention for portable power inverters for use in pickup trucks having high capacity batteries. An inverter 32 is connected to a toolbox 12 (shown in FIG. 4) for added heat dissipation, ground fault interrupter circuits and battery isolation circuit is illustrated and will be described. More particularly, the high capacity mobile electric power source 10 has the toolbox 12 for attachment to the truck bed. The toolbox 12 has a lid 14 (shown in FIG. 4). The toolbox 12 has a rear-gate facing wall 16 (shown in FIG. 4). The toolbox 12 has two opposite sidewalls, a driver side sidewall 18 (shown in FIG. 4) and a passenger side sidewall 20 (shown in FIG. 4). The toolbox 12 has a bottom 22 (shown in FIG. 4). The toolbox 12 has an interior 24 (shown in FIG. 4). A battery 26 is connected to the toolbox bottom 22 within the toolbox interior 24 approximately equally spaced from the driver side sidewall 18 and the passenger side sidewall 20 for balanced weight distribution between the driver side sidewall 18 and the passenger side sidewall 20. The toolbox 12 has a battery area that comprises an exterior vent to vent the battery 26 to alleviate corrosion problems; additionally, the battery employed in the present invention have relatively low outgassing properties. The battery 26 is high capacity, sealed, maintenance free, 12-volt direct current battery. The battery 26 has a positive pole connection 28. The battery 26 has the negative pole connection 28. The inverter 32 is connected to the toolbox rear-gate facing wall 16 within the toolbox interior 24. The inverter 32 is in thermal communication with the toolbox rear-gate facing wall 16 for enhanced thermal dissipation. The inverter 32 is electrically connected to the battery positive pole connection 28. The inverter 32 is electrically connected to a battery negative pole connection 30. A first electrical outlet 34 is connected to the toolbox rear-gate facing wall 16 adjacent the driver side sidewall 18. The first electrical outlet 34 is the ground fault interruption electrical outlet. The first electrical outlet 34 is electrically connected to the inverter 32. A second electrical outlet 38 is connected to the toolbox rear-gate facing wall 16 adjacent the passenger side sidewall 20. The second electrical outlet 38 is the ground fault interruption electrical outlet. The second electrical outlet 38 is electrically connected to the inverter 32. An isolator circuit 42 (shown in FIG. 2) is electrically connected to the battery positive pole connection 28. The isolator circuit 42 is for electrically disconnecting from the battery positive pole connection 28 if voltage should exceed 13.5 VDC. A first electrical outlet cover 36 (shown in FIG. 4) is pivotally connected to the first electrical outlet 34. A second electrical outlet cover 40 (shown in FIG. 4) is pivotally connected to the second electrical outlet 38. A shelf 44 (shown in FIG. 4) is detachably connectable to the toolbox interior 24 for placement above the battery 26. A charging circuit 46 is electrically connected to the battery positive pole connection 28. The charging circuit 46 is for providing a predetermined optimal charging profile for the battery 26. The optimal charging profile is selected to maximize both battery storage capacity and the potential number of recharge cycles. A positive voltage connection cable 48 is electrically connected to the battery positive pole connection 28. A negative voltage connection cable 50 is electrically connected to the battery negative pole connection 28. A secondary alternator 52 is electrically connected to the battery positive pole connection 28.

FIG. 1 illustrates an embodiment of the high capacity mobile electric power source were the system is installed so as to be electrically separate from the existing vehicle battery, alternator and starter. In this embodiment the high performance battery pack is installed in the convenient location on the vehicle. In the preferred embodiment this battery pack will be packaged in the enclosure along with the heavy duty inverter and power receptacles. The battery pack is made up of one or more 12 volt DC batteries of 100 Ahr capacity or greater. Where there is more than one battery the batteries are directly connected in parallel one to another via copper bus bars. Copper bus bar connectors are employed to minimize connectivity resistance both at the bus bar to battery terminal connection and within the: pack between the other batteries. In a present embodiment, the bus bar defines a thin, flat shape to absorb vibration and movement within the battery pack while maintaining tight connections. The thin, flat shape of the bus bars of the present invention allows tight, efficient packaging of the batteries within the tool box. The battery pack is electrically connected to the heavy duty inverter which converts 12 VDC input current into 120 VAC output current. The power outlets may consist of the combination of one or more 120 VAC ground fault circuit interrupter receptacles, 120 VAC 30 Amp receptacle, 120 VAC 50 Amp receptacle, 120 VAC power strip, 12 VDC receptacle and 12 VDC jumper cable connection. Additionally the alternate inverter may be installed with the system to provide 220 VAC power. The high performance battery pack is electrically connected to the additional high amp output alternator installed on the vehicle engine. This alternator is controlled by the charge controller consisting of the voltage regulator and the proprietary charge profile program. This controller combined with the output of the high amp alternator insures that the battery pack is recharged in such a manner as to minimize sulfation of the battery grids and maintain maximum electrical capacity and cycling life. This charging profile also minimizes out gassing of the batteries which are vented to the exterior of the enclosure and or vehicle to avoid corrosion. By keeping the high capacity electric power source system separate from the vehicle's existing alternator and battery the high performance battery pack can be charged using the desired current rate and time profile without being compromised by the different charging needs of the existing vehicle battery. It also avoids the need to install the battery isolator though the additional high amp output alternator is required to be installed.

In FIG. 2, the high capacity mobile electric power source 10 of the present invention is illustrated and will be described. More particularly, the high capacity mobile electric power source 10 has the toolbox 12 (shown in FIG. 4) for attachment to the truck bed. The battery 26 is high capacity, sealed, maintenance free, 12-volt direct current battery. The battery 26 has the positive pole connection 28. The battery 26 has the negative pole connection 28. The inverter 32 is electrically connected to the battery positive pole connection 28. The inverter 32 is electrically connected to the battery negative pole connection 30. The first electrical outlet 34 is the ground fault interruption electrical outlet. The first electrical outlet 34 is electrically connected to the inverter 32. The second electrical outlet 38 is the ground fault interruption electrical outlet. The second electrical outlet 38 is electrically connected to the inverter 32. The isolator circuit 42 is electrically connected to the battery positive pole connection 28. The isolator circuit 42 is for electrically disconnecting from the battery positive pole connection 28 if voltage should exceed 13.5 VDC. The charging circuit 46 is electrically connected to the battery positive pole connection 28. The charging circuit 46 is for providing the optimal charging profile for the battery 26. The positive voltage connection cable 48 is electrically connected to the battery positive pole connection 28. The negative voltage connection cable 50 is electrically connected to the battery negative pole connection 28. The secondary alternator 52 is electrically connected to the battery positive pole connection 28.

FIG. 2 illustrates an embodiment of the high capacity mobile electric power source were the existing vehicle alternator is replaced with the high amp output alternator and the system is installed so as to electrically integrate with the existing vehicle battery and starter using the battery isolator. In this embodiment the high performance battery pack is installed in the convenient location on the vehicle. In the preferred embodiment this battery pack will be packaged in the enclosure along with the heavy duty inverter and power receptacles. The battery pack is made up of one or more 12 volt DC batteries of 100 Ahr capacity or greater. Where there is more than one battery the batteries are directly connected in parallel one to another via copper bus bars. The battery pack is electrically connected to the heavy duty inverter which converts 12 VDC input current into 120 VAC output current. The power outlets may consist of the combination of one or more 120 VAC ground fault circuit interrupter receptacles, 120 VAC 30 Amp receptacle, 120 VAC 50 Amp receptacle, 120 VAC power strip, 12 VDC receptacle and 12 VDC jumper cable connection. Additionally the alternate inverter may be installed with the system to provide 220 VAC power. The high performance battery pack is electrically connected to the newly installed high amp output alternator and existing vehicle battery through the battery isolator. The isolator is the automatic electric switch which allows two batteries to be charged from the same source while preventing the lesser charged battery from depleting the other. The alternator is controlled by the charge controller consisting of the voltage regulator and the proprietary charge profile program. This controller combined with the output of the high amp alternator insures that the battery pack is recharged in such a manner as to minimize sulfation of the battery grids and maintain maximum electrical capacity and cycling life. This charging profile also minimizes out gassing of the batteries which are vented to the exterior of the enclosure and or vehicle to avoid corrosion. By keeping the high capacity electric power source system battery pack electrically isolated from the vehicle's existing battery the high performance battery pack can be charged using the desired current rate and time profile from the high amp output alternator while minimizing detrimental affects on the existing vehicle battery. It also avoids the need to install and run the additional alternator on the vehicle.

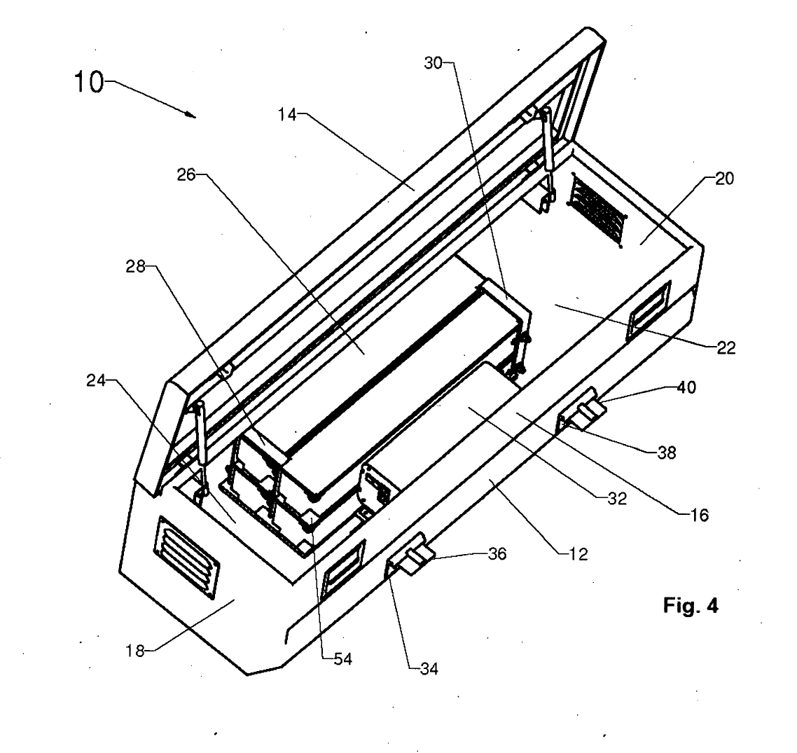

In FIG. 3, the high capacity mobile electric power source 10 of the present invention is illustrated and will be described. More particularly, the high capacity mobile electric power source 10 has the toolbox 12 (shown in FIG. 4) for attachment to the truck bed. The battery 26 is high capacity, sealed, maintenance free, 12-volt direct current battery. The battery 26 has the positive pole connection 28. The battery 26 has the negative pole connection 28. The inverter 32 is electrically connected to the battery positive pole connection 28. The inverter 32 is electrically connected to the battery negative pole connection 30. The first electrical outlet 34 is the ground fault interruption electrical outlet. The first electrical outlet 34 is electrically connected to the inverter 32. The second electrical outlet 38 is the ground fault interruption electrical outlet. The second electrical outlet 38 is electrically connected to the inverter 32. The charging circuit 46 is electrically connected to the battery positive pole connection 28. The charging circuit 46 is for providing the optimal charging profile for the battery 26. The positive voltage connection cable 48 is electrically connected to the battery positive pole connection 28. The negative voltage connection cable 50 is electrically connected to the battery negative pole connection 28. The secondary alternator 52 is electrically connected to the battery positive pole connection 28.

FIG. 3 illustrates the preferred embodiment of the high capacity mobile electric power source were the existing vehicle alternator is replaced with the high amp output alternator and the existing vehicle battery is replaced by the system battery pack. In this embodiment the high performance battery pack is installed in the convenient location on the vehicle. In the preferred embodiment this battery pack will be packaged in the enclosure along with the heavy duty inverter and power receptacles. The battery pack is made up of one or more 12 volt DC batteries of 100 Ahr capacity or greater. Where there is more than one battery the batteries are directly connected in parallel one to another via copper bus bars. The battery pack is electrically connected to the heavy duty inverter which converts 12 VDC input current into 120 VAC output current. The power outlets may consist of the combination of one or more 120 VAC ground fault circuit interrupter receptacles, 120 VAC 30 Amp receptacle, 120 VAC 50 Amp receptacle, 120 VAC power strip, 12 VDC receptacle and 12 VDC jumper cable connection. Additionally the alternate inverter may be installed with the system to provide 220 VAC power. The high performance battery pack is electrically connected to the newly installed high amp output alternator. The battery pack serves as the vehicle battery for all starting and chassis electrical needs. The alternator is controlled by the charge controller consisting of the voltage regulator and the proprietary charge profile program. This controller combined with the output of the high amp alternator insures that the battery pack is recharged in such a manner as to minimize sulfation of the battery grids and maintain maximum electrical capacity and cycling life. This charging profile also minimizes out gassing of the batteries which are vented to the exterior of the enclosure and or vehicle to avoid corrosion. Utilizing the high capacity electric power source system battery pack as the vehicle battery eliminates the need for the battery isolator or the additional alternator. Further it allows the battery pack to be charged using the desired current rate and time profile from the high amp output alternator without being compromised by the different charging needs of the existing vehicle battery.

In FIG. 4, the high capacity mobile electric power source 10 of the present invention is illustrated and will be described. More particularly, the high capacity mobile electric power source 10 has the toolbox 12 for attachment to the truck bed. The toolbox 12 has the lid 14. The toolbox 12 has the rear-gate facing wall 16. The toolbox 12 has two opposite sidewalls, the driver side sidewall 18 and the passenger side sidewall 20. The toolbox 12 has the bottom 22. The toolbox 12 has the interior 24. The battery 26 is connected to the toolbox bottom 22 within the toolbox interior 24 approximately equally spaced from the driver side sidewall 18 and the passenger side sidewall 20 for balanced weight distribution between the driver side sidewall 18 and the passenger side sidewall 20. Vents are illustrated on the sidewalls 18, 20. These vents allow for additional thermal dissipation. The vented thermal dissipation may take place by passive venting, or an optional fan may be included for forced air venting. The inverter 32 is connected to the toolbox rear-gate facing wall 16 within the toolbox interior 24. The inverter 32 is in thermal communication with the toolbox rear-gate facing wall 16 for enhanced thermal dissipation. The first electrical outlet 34 is connected to the toolbox rear-gate facing wall 16 adjacent the driver side sidewall 18. The second electrical outlet 38 is connected to the toolbox rear-gate facing wall 16 adjacent the passenger side sidewall 20. The first electrical outlet cover 36 is pivotally connected to the first electrical outlet 34. The second electrical outlet cover 40 is pivotally connected to the second electrical outlet 38. The shelf 44 is detachably connectable to the toolbox interior 24 for placement above the battery 26.

FIG. 4 illustrates the preferred embodiment of the high capacity mobile electric power source were the high performance battery pack consisting of four batteries 26 is shown electrically connected with bus bars and installed in the enclosure with the heavy duty inverter. Two 120 VAC GFCI outlets 34, 38 are shown on the exterior of the enclosure 12. Although conventional outlets and conventional pivoting outlet covers 36, 40 are shown and described herein, those skilled in the art will readily appreciate that any known electrical connector or outlet may be employed to tap the power provided by the present invention. The electrical outlets 34, 38 and outlet covers 36, 40 shown and described herein are provided as a preferred method of providing a weather-protected outlet panel, but any form of a power tap, outlet or receptacle may be employed without deviating from the spirit and scope of the invention. For example, conventional 120V outlets of both the 15 A and 20 A varieties, a 120V 30 A outlet, a 220V outlet, a 12V cigarette plug, 12V high current jumper connections or a variety of other power taps may be used: the present invention provides a power source, and is not dependent upon the type of connector used to tap the power of said power source or the placement thereof.

In operation it can be seen that the device contains the battery consisting of one or more 12 VDC batteries connected in the parallel circuit. The battery in turn is electrically connected to the inverter which converts 12 VDC input current into 120 VAC output current. This 120 VAC output is electrically connected to one or more receptacles mounted so as to be accessible from the exterior of the truck box. The user would connect the standard electric extension cord or device such as the electric drill or circular saw directly to the receptacle. Power would be instantly available. These external receptacles are ground fault protected to guard against electric shock to the user. The inverter also contains the number of safety related devices such as the low voltage alarm and electrical shutoff which would prompt the user to recharge the battery. The battery is recharged through electrical connections made to the existing engine alternator or to the supplemental alternator installed for the exclusive purpose of recharging this battery. Recharging occurs during normal driving of the vehicle or by idling the engine if needed. The charge state of the battery is assessed by the charging circuit. The charging circuit controls the charging current flow from the alternator according to the special algorithm in order to maximize battery storage capacity and condition while avoiding charging profiles which would be detrimental to battery life.

The device contains the battery pack consisting of one or more 12 VDC batteries of 100 Ahr capacity or greater connected in the parallel circuit. The battery pack in turn is electrically connected to the inverter which converts 12 VDC input current into 120 VAC output current. This 120 VAC output is electrically connected to one or more receptacles positioned so as to be accessible from the exterior of the enclosure. With the vehicle engine off, the user would connect the standard electric extension cord or device such as the electric-drill or circular saw directly to the exterior receptacle. Power would be instantly available. These external accessible receptacles are ground fault protected to guard against electric shock to the user. The inverter contains the low voltage disconnect that prevents the batteries from being discharged below a predetermined point by shutting off all AC power loads. This protects the construction, chemistry and service life of the batteries and insures that there is ample power to restart the vehicle engine. The audible low voltage alarm prompts the user to start the engine to recharge the battery pack. The battery pack is recharged through electrical connections made to the engine alternator or to the supplemental alternator installed for the exclusive purpose of recharging this pack. Recharging occurs during normal driving of the vehicle or by idling the engine if needed. The charge state of the battery pack is assessed by the voltage regulator. The voltage regulator controls the charging current flow from the alternator according to the special algorithm in order to maximize battery storage capacity and condition while avoiding charging profiles which would be detrimental to battery life. This charging profile also minimizes out gassing of the batteries which in all embodiments are vented to the exterior of the enclosure and or vehicle to avoid corrosion.

While the preferred embodiment of the high capacity mobile electric power source has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present embodiment of the invention. For example, any suitable sturdy toolbox material may be used instead of the stainless steel described.

Therefore, the foregoing is considered as illustrative only of the principles of the embodiment of the invention. Further, since numerous modifications and changes will readily occur to those skilled in the art, it is not desired to limit the embodiment of the invention to the exact construction and operation shown and described, and accordingly, all suitable modifications and equivalents may be resorted to, falling within the scope of the embodiment of the invention.

We claim:

1. An high capacity mobile electric power source comprising:
a toolbox for attachment to a truck bed, said toolbox having a lid, said toolbox having a rear-gate facing wall, said toolbox having two opposite side walls, a driver side sidewall and a passenger side sidewall, said toolbox having a bottom, said toolbox having an interior and an exterior;
a battery connected to said toolbox bottom within said toolbox interior approximately equally spaced from said driver side sidewall and said passenger side sidewall for balanced weight distribution between said driver side sidewall and said passenger side sidewall, said battery being high capacity, sealed, maintenance free, 12 volt direct current battery, said battery having a positive pole connection, said battery having a negative pole connection;
an inverter connected to said toolbox rear-gate facing wall within said toolbox interior, said inverter in thermal communication with said toolbox rear-gate facing wall for enhanced thermal dissipation, said inverter is electrically connected to said battery positive pole connection; and
a first electrical outlet connected to said toolbox rear-gate facing wall adjacent said driver side sidewall, said first electrical outlet is electrically connected to said inverter.

2. The high capacity mobile electric power source of claim 1 further comprising:
a second electrical outlet connected to said toolbox rear-gate facing wall adjacent said passenger side sidewall, said second electrical outlet is electrically connected to said inverter.

3. The high capacity mobile electric power source of claim 1 wherein:
said first electrical outlet is a ground fault interruption electrical outlet.

4. The high capacity mobile electric power source of claim 2 wherein:
said second electrical outlet is a ground fault interruption electrical outlet.

5. The high capacity mobile electric power source of claim 1 further comprising:
a first electrical outlet cover pivotally connected to said first electrical outlet.

6. The high capacity mobile electric power source of claim 2 further comprising:
a second electrical outlet cover pivotally connected to said second electrical outlet.

7. The high capacity mobile electric power source of claim 1 wherein:
said toolbox defines a vent therein to externally vent said battery to said toolbox exterior.

8. The high capacity mobile electric power source of claim 1 further comprising:
a shelf detachably connectable to said toolbox interior for placement above said battery.

9. The high capacity mobile electric power source of claim 1 further comprising:
a charging circuit electrically connected to said battery positive pole connection, said charging circuit for providing an optimal charging profile for said battery.

10. The high capacity mobile electric power source of claim 1 further comprising:
an isolator circuit electrically connected to said battery positive pole connection, said isolator circuit for electrically disconnecting from said battery positive pole connection if voltage should exceed 13.5 VDC.

11. The high capacity mobile electric power source of claim 1 further comprising:
a positive voltage connection cable electrically connected to said battery positive pole connection; and
a negative voltage connection cable electrically connected to said battery negative pole connection.

12. An high capacity mobile electric power source of claim 1 further comprising:
a secondary alternator electrically connected to said battery positive pole connection.

13. An high capacity mobile electric power source comprising:
a toolbox for attachment to a truck bed, said toolbox having a lid, said toolbox having a rear-gate facing wall, said toolbox having two opposite side walls, a driver side sidewall and a passenger side sidewall, said toolbox having a bottom, said toolbox having an interior and an exterior;
a battery connected to said toolbox bottom within said toolbox interior approximately equally spaced from said driver side sidewall and said passenger side sidewall for balanced weight distribution between said driver side sidewall and said passenger side sidewall, said battery being high capacity, sealed, maintenance free, 12 volt direct current battery, said battery having a positive pole connection, said battery having a negative pole connection;
an inverter connected to said toolbox rear-gate facing wall within said toolbox interior, said inverter in thermal communication with said toolbox rear-gate facing wall for enhanced thermal dissipation, said inverter electrically connected to said battery positive pole connection;
a first electrical outlet connected to said toolbox rear-gate facing wall adjacent said driver side sidewall, said first electrical outlet is electrically connected to said inverter; and
a second electrical outlet connected to said toolbox rear-gate facing wall adjacent said passenger side sidewall, said second electrical outlet is electrically connected to said inverter.

14. The high capacity mobile electric power source of claim 13 wherein:
said first electrical outlet is a ground fault interruption electrical outlet; and
said second electrical outlet is a ground fault interruption electrical outlet.

15. The high capacity mobile electric power source of claim 14 further comprising:
a first electrical outlet cover pivotally connected to said first electrical outlet; and
a second electrical outlet cover pivotally connected to said second electrical outlet.

16. The high capacity mobile electric power source of claim 15 wherein:
said toolbox defines a vent therein to externally vent said battery to said toolbox exterior.

17. The high capacity mobile electric power source of claim 16 further comprising:
a shelf detachably connectable to said toolbox interior for placement above said battery.

18. The high capacity mobile electric power source of claim 17 further comprising:
a charging circuit electrically connected to said battery positive pole connection, said charging circuit for providing an optimal charging profile for said battery.

19. The high capacity mobile electric power source of claim 18 further comprising:
an isolator circuit electrically connected to said battery positive pole connection, said isolator circuit for electrically disconnecting from said battery positive pole connection if voltage should exceed 13.5 VDC.

20. The high capacity mobile electric power source of claim 19 further comprising:
a positive voltage connection cable electrically connected to said battery positive pole connection; and
a negative voltage connection cable electrically connected to said battery negative pole connection.

21. The high capacity mobile electric power source of claim 20 further comprising:
a secondary alternator electrically connected to said battery positive pole connection.

22. An high capacity mobile electric power source comprising:
a toolbox for attachment to a truck bed, said toolbox having a lid, said toolbox having a rear-gate facing wall, said toolbox having two opposite side walls, a driver side sidewall and a passenger side sidewall, said toolbox having a bottom, said toolbox having an interior and an exterior;
a battery connected to said toolbox bottom within said toolbox interior approximately equally spaced from said driver side sidewall and said passenger side sidewall for balanced weight distribution between said driver side sidewall and said passenger side sidewall, said battery being high capacity, sealed, maintenance free, 12 volt direct current battery, said battery having a positive pole connection, said battery having a negative pole connection;
an inverter connected to said toolbox rear-gate facing wall within said toolbox interior, said inverter in thermal communication with said toolbox rear-gate facing wall for enhanced thermal dissipation, said inverter is electrically connected to said battery positive pole connection;
a first electrical outlet connected to said toolbox rear-gate facing wall adjacent said driver side sidewall, said first electrical outlet is electrically connected to said inverter;
a second electrical outlet connected to said toolbox rear-gate facing wall adjacent said passenger side sidewall, said second electrical outlet is electrically connected to said inverter; and
a charging circuit electrically connected to said battery positive pole connection, said charging circuit for providing an optimal charging profile for said battery.

23. The high capacity mobile electric power source of claim 22 wherein:
said first electrical outlet is a ground fault interruption electrical outlet; and
said second electrical outlet is a ground fault interruption electrical outlet.

24. The high capacity mobile electric power source of claim 22 further comprising:
a first electrical outlet cover pivotally connected to said first electrical outlet; and
a second electrical outlet cover pivotally connected to said second electrical outlet.

25. The high capacity mobile electric power source of claim 22 wherein:
said toolbox is said toolbox defines a vent therein to externally vent said battery to said toolbox exterior.

26. The high capacity mobile electric power source of claim 22 further comprising:
a shelf detachably connectable to said toolbox interior for placement above said battery.

27. The high capacity mobile electric power source of claim 22 further comprising:
an isolator circuit electrically connected to said battery positive pole connection, said isolator circuit for electrically disconnecting from said battery positive pole connection if voltage should exceed 13.5 VDC.

28. The high capacity mobile electric power source of claim 22 further comprising:
a positive voltage connection cable electrically connected to said battery positive pole connection; and
a negative voltage connection cable electrically connected to said battery negative pole connection.

29. The high capacity mobile electric power source of claim 22 further comprising:
a secondary alternator electrically connected to said battery positive pole connection.

30. An high capacity mobile electric power source comprising:
a toolbox for attachment to a truck bed, said toolbox having a lid, said toolbox having a rear-gate facing wall, said toolbox having two opposite side walls, a driver side sidewall and a passenger side sidewall, said toolbox having a bottom, said toolbox having an interior and an exterior;
a battery connected to said toolbox bottom within said toolbox interior approximately equally spaced from said driver side sidewall and said passenger side sidewall for balanced weight distribution between said driver side sidewall and said passenger side sidewall, said battery being high capacity, sealed, maintenance free, 12 volt direct current battery, said battery having a positive pole connection, said battery having a negative pole connection;
an inverter connected to said toolbox rear-gate facing wall within said toolbox interior, said inverter in thermal communication with said toolbox rear-gate facing wall for enhanced thermal dissipation, said inverter electrically connected to said battery positive pole connection;
a first electrical outlet connected to said toolbox rear-gate facing wall adjacent said driver side sidewall, said first electrical outlet is electrically connected to said inverter;
a second electrical outlet connected to said toolbox rear-gate facing wall adjacent said passenger side sidewall, said second electrical outlet is electrically connected to said inverter; and
an isolator circuit electrically connected to said battery positive pole connection, said isolator circuit for electrically disconnecting from said battery positive pole connection if voltage should exceed 13.5 VDC.

31. The high capacity mobile electric power source of claim 30 wherein:
said first electrical outlet is a ground fault interruption electrical outlet; and
said second electrical outlet is a ground fault interruption electrical outlet.

32. The high capacity mobile electric power source of claim 30 further comprising:
a first electrical outlet cover pivotally connected to said first electrical outlet; and
a second electrical outlet cover pivotally connected to said second electrical outlet.

33. The high capacity mobile electric power source of claim 30 wherein:
said toolbox is said toolbox defines a vent therein to externally vent said battery to said toolbox exterior.

34. The high capacity mobile electric power source of claim 30 further comprising:
a shelf detachably connectable to said toolbox interior for placement above said battery.

35. The high capacity mobile electric power source of claim 30 further comprising:
a charging circuit electrically connected to said battery positive pole connection, said charging circuit for providing an optimal charging profile for said battery.

36. The high capacity mobile electric power source of claim 30 further comprising:
a positive voltage connection cable electrically connected to said battery positive pole connection; and
a negative voltage connection cable electrically connected to said battery negative pole connection.

37. The high capacity mobile electric power source of claim 30 further comprising:
a secondary alternator electrically connected to said battery positive pole connection.

38. An high capacity mobile electric power source comprising:
a toolbox for attachment to a truck bed, said toolbox having a lid, said toolbox having a rear-gate facing wall, said toolbox having two opposite side walls, a driver side sidewall and a passenger side sidewall, said toolbox having a bottom, said toolbox having an interior;
a battery connected to said toolbox bottom within said toolbox interior approximately equally spaced from said driver side sidewall and said passenger side sidewall for balanced weight distribution between said driver side sidewall and said passenger side sidewall, said battery being high capacity, sealed, maintenance free, 12 volt direct current battery, said battery having a positive pole connection, said battery having a negative pole connection;
an inverter connected to said toolbox rear-gate facing wall within said toolbox interior, said inverter in thermal communication with said toolbox rear-gate facing wall for enhanced thermal dissipation, said inverter is electrically connected to said battery positive pole connection;
a first electrical outlet connected to said toolbox rear-gate facing wall adjacent said driver side sidewall, said first electrical outlet is a ground fault interruption electrical outlet, said first electrical outlet is electrically connected to said inverter;
a second electrical outlet connected to said toolbox rear-gate facing wall adjacent said passenger side sidewall, said second electrical outlet is a ground fault interruption electrical outlet, said second electrical outlet is electrically connected to said inverter;
an isolator circuit electrically connected to said battery positive pole connection, said isolator circuit for electrically disconnecting from said battery positive pole connection if voltage should exceed 13.5 VDC;
a first electrical outlet cover connected to said first electrical outlet;
a second electrical outlet cover connected to said second electrical outlet;
a shelf detachably connectable to said toolbox interior for placement above said battery;
a charging circuit electrically connected to said battery positive pole connection, said charging circuit for providing an optimal charging profile for said battery;
a positive voltage connection cable electrically connected to said battery positive pole connection;
a negative voltage connection cable electrically connected to said battery negative pole connection; and
a secondary alternator electrically connected to said battery positive pole connection.

39. The high capacity mobile electric power source of claim 38 further comprising:
a plurality of said batteries in electrical connection with each other.

40. The high capacity mobile electric power source of claim 39 wherein:
said electrical connection of said plurality of batteries is made via a copper bus bar.
